(19) United States
(12) Patent Application Publication
(10) Pub. No.: US 2006/0204141 A1
(43) Pub. Date: Sep. 14, 2006

(54) Method and system of converting film images to digital format for viewing

(76) Inventors: James Modrall, Pleasanton, CA (US); Brian Porter, San Francisco, CA (US); Bruce Zeuli, Benicia, CA (US)

Correspondence Address: Sean M. Fitzgerald, 3182 Campus Drive #342, San Mateo, CA, 94403-3123, US

(21) Appl. No.: 11/070,857

(22) Filed: Mar. 1, 2005

(51) Int. Cl. G06F 17/00; G06K 9/54

(52) U.S. Cl. 382/305; 707/104.1

(57) ABSTRACT

One example embodiment provides a method and system converting image files from a roll scanner into a file format suitable for viewing the images in a roll format. The image processor receives the output files from the roll scanner. The image processor determines the orientation of the output images in relation to the roll they were taken from. A meta-data file including the proper orientation information is created and associated with the output images. The meta-data file includes information specifying the relative orientation and positioning of the output images.

### BACKGROUND

1. Field of the Invention

The field of the invention relates generally to systems for converting hard copy images to digital files for viewing and storage.

2. Related Background

Storage and viewing of historical documents has always been a cumbersome task. Documents stored in book form were prone to damage and loss. Conversion of paper records to microfilm or microfiche reduced warehousing and storage costs, and were generally less prone to damage and loss than paper. However, microfilm and microfiche are not immune from damage, and copying and storing duplicate copies is both time consuming and costly. Additionally, locating a particular document or page of a document in a microfilm or microfiche record can be cumbersome and time consuming task. Often, a person searching a record may only view the microfilm or microfiche with a special viewing machine, typically only available in a library or records office, and with limited access. Actually locating the desired document or page often requires scrolling through considerable numbers of documents or pages.

Systems exist to convert microfilm or microfiche images to digital format. One example of such a system is the RS300 Scanstation microfilm scanner made by Wicks and Wilson™ which can take digital photographs of roll film such as microfilm and outputs a digital file for each snapshot taken. Other general purpose and specialized systems exist which may convert roll film into a digital image.

Accordingly, the present invention seeks to overcome the limitations of prior document storage and viewing systems.

### BRIEF DESCRIPTION OF THE FIGURES

FIG. 1 is a generalized block diagram of a computer system that may be used to implement the present invention, according to one embodiment of the invention.

FIG. 2 is a generalized block diagram of a software architecture that may be used to implement the present invention, according to one embodiment of the invention.

FIG. 3 is a generalized block diagram of a computer system that may be used to implement the present invention, according to one embodiment of the invention.

FIG. 4 is a generalized block diagram of images from a reel scanner illustrating the orientation of the images, according to one embodiment of the invention.

FIG. 5 is a generalized flow diagram illustrating a process of creating meta data files for viewing the digital image files of the roll image, according to one alterative embodiment of the invention.

FIG. 6 is a generalized block diagram illustrating the output files of the process of creating image viewing meta-data files, according to one embodiment of the invention.

FIG. 7 is a generalized flow diagram illustrating the process of preparing the digital image files output from the reel scanner for viewing by a viewer, according to one embodiment of the invention.

### SUMMARY

The present invention provides a system and method of converting hard copy images to a digital format for storage and viewing. To allow viewing of a group of images in a scrolling format, an image interpretation file is created for use by a viewer. In one example embodiment, a roll film is digitized into a group of digital images by a scanner. The group o digital image files are processed by the present invention to create the image interpretation file which may include identifying information, image file sequence information (viewing order), image file or image object identifying information or content information, image object position or location information, associated thumbnail information, security information, or information relating to a second roll film. The information included in the image interpretation file may be gathered from the output of the scanner, from settings entered by the scanner operator, by settings entered or uploaded during processing to create the meta-data in the image interpretation file, or from processing the image files.

### DETAILED DESCRIPTION

The present invention is described in the context of a specific embodiment. This is done to facilitate the understanding of the features and principles of the present invention and the present invention is not limited to this embodiment. In particular, the present invention is described in the context of a system for converting documents stored on rolls of microfilm to a digital format for viewing and storage. The present invention is applicable to other systems for viewing, storing and retrieving documents and images.

The example embodiment provides for a system and method of converting roll film to digital images. As used in the present application, the term roll film is used to include all types of roll images, whether microfilm, microfiche, 35 mm film, other formats of photographic film, or other types of roll images on film, paper or other medium. As used in the present invention, roll images is used to include any image having one dimension much greater than another dimension, one example of which is a roll of film which, when unspooled, extends to a length much greater than the width of the film. As with a roll of film, a roll image may include multiple individual images, as with a roll of 35 mm photographic film, or may include only one extended image.

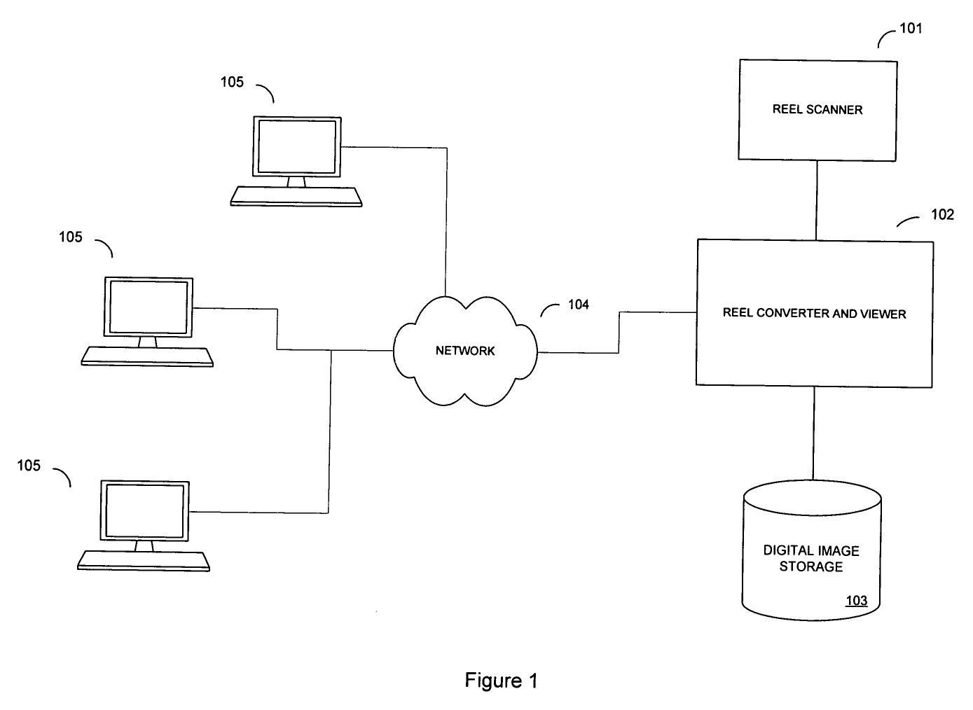

FIG. 1 is a block diagram of a computer system 100 that may be used to implement embodiments of the present invention. A reel scanner 101 is connected to a reel converter and viewer server 102. The reel converter and viewer server 102 is connected to a digital image storage repository 103 and communications network 104. End-user communication devices 105 are connected to the digital image repository through the communications network 104. The end-user communications devices may be used to view digital images processed by the present invention with a viewer described below. The content servers are the servers used to manage content which end-users wish to access.

One example of a reel scanner is the RS300 Scanstation microfilm scanner made by Wicks and Wilson™. The RS300 microfilm scanner can take digital photographs of roll film such as microfilm and outputs a digital file for each snapshot taken. The snapshot taken represents a single portion of the roll of microfilm. Typically, this single portion represents a few inches of the roll of microfilm. To digitally record an entire roll of microfilm, it is typically necessary to take multiple snapshots of the different segments of the roll of microfilm. Accordingly, the output from a scanner like the RS300 is a series of digital files representing digital images of segments of the roll of microfilm.

While the presently preferred embodiment utilizes a specialized device for scanning roll film images, alternate embodiments of the present invention could use either specialized scanners or general purpose scanners. For example, the present application could be used with general purpose scanners used in scanning images into a format readable by a personal computer. Other examples of general purpose scanners include digital copiers.

In the presently preferred embodiment, the end-user viewing device is a personal computer. Additionally, in the presently preferred embodiment the communications network is the Internet. Connection to the Internet could be by any form of Internet connection, including broadband and wireless connection. Alternatively, a private network or direct link could be established between the reel converter and viewer server and the viewing device. Alternatively, the end user communications device could be a mobile phone (including web enabled mobile phones or mobile phones with text messaging capabilities), standard telephone, PDA or any other device capable of receiving text or voice messages.

The reel converter and viewer server could be implemented on one single server or on multiple servers. Similarly, the digital image storage server could be implemented on one single server or on multiple servers, or could be combined on the same computer as the reel converter and viewer server. Actual storage of the digital images and assorted files could be in the memory of the digital image storage server, on the hard drive of the digital image storage server, on hard drives of a storage device communicatively connected to the digital image storage server, or on other media of storage such as magnetic tape, optical storage, etc. As used in the present application, the term server may refer to a physical computer or to software performing the functions of a server.

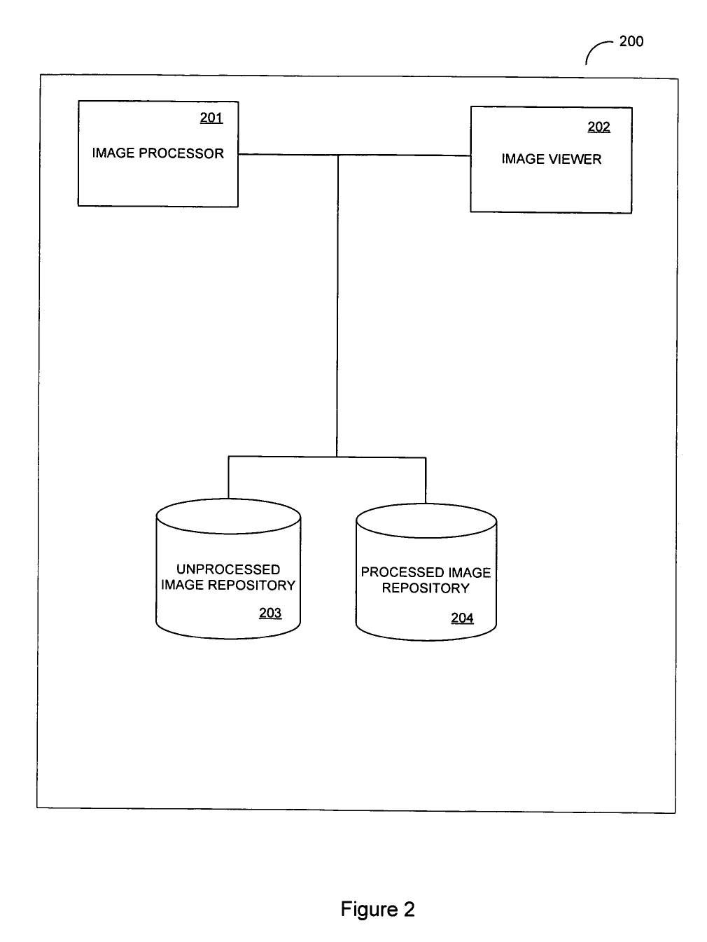

FIG. 2 is a generalized block diagram of the reel converter and viewer server shown in FIG. 1. The reel converter and viewer server 200 includes an image processor 201 for processing the image segments received from the reel scanner into a format viewable as a roll image. Images received from the reel scanner are stored in an unprocessed image repository 203. Images processed by the image processor 201 to a format viewable as a roll image are stored in the processed image repository 204. A digital reel viewer 202 allows processed images to be viewed in roll form by an end user accessing the reel converter and viewer server.

In the presently preferred embodiment, the digital reel image viewer is a separate software program. In one embodiment of the present invention the digital reel image viewer is installed on an end user communications device such as a PC. Typically, in such an implementation, the end user would not have access, via the digital reel image viewer, to the unprocessed digital images (although alternate embodiments may provide such access). The processed image repository may be located on the end-user communications device, on a storage medium accessible by the end-user communications device, or accessible by the end-user communications device over a communications network. Alternate embodiments of the present invention could use a client-server implementation to view images on a client installed on the end-user communications device, including, for example, a web browser capable of accessing and displaying digital reel images from a digital reel image web server.

While the presently preferred embodiment utilizes both the unprocessed image repository and the processed image repository on the same host computer as the image processor and the digital reel viewer, alternate embodiments of the present invention could utilize any or all of these components on different host computers. Additionally, any or all of the components of the reel converter and viewer server may be split among several host computers in alternate embodiments of the present invention.

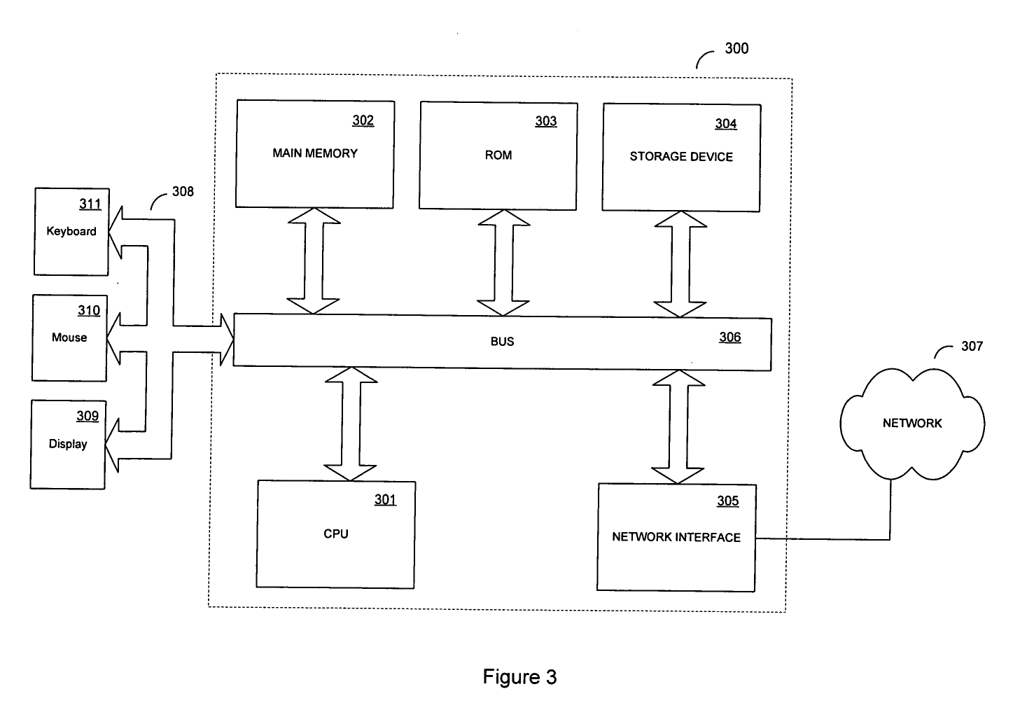

FIG. 3 is a generalized block diagram of a reel converter and viewer server computer 300 including a central processing unit (CPU) 301, main memory (typically RAM) 302, read-only memory (ROM) 303, a storage device (typically a hard drive) 304, and a network device (typically a network interface card, a.k.a. NIC) 305. The network device connects to a communications network 307. The server includes a bus 306 or other communication mechanism for communicating information between the CPU 301 coupled with bus 306. The CPU 301 is used for processing instructions and data. The main memory 302, ROM 303 and storage device 304 are coupled to bus 306 and store information and instructions to be executed by processor 301. Main memory 302 also may be used for storing temporary variables or other intermediate information during execution of instructions to be executed by processor 301.

Server 300 may be coupled via bus 308 to a display 309, such as a cathode ray tube (CRT) or flat panel monitor, for displaying information to a computer user. An input device 310, such as a keyboard, is coupled to bus 308 for entering information and instructions to the server 300. Additionally, a user input device 311 such as a mouse, a trackball, or cursor direction keys for communicating direction information and command selections to the processor 301 and for controlling cursor movement on the display 309 may be used with the server 300.

The server 300 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 301 for execution. Such a medium may take many forms including, but not limited to, non-volatile media, volatile media, and transmission media. Examples of non-volatile media include, for example, optical or magnetic disks, such as storage device 304. Examples of volatile media include dynamic memory, such as main memory 302. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 306 and 308. Transmission media can also take the form of acoustic, electromagnetic or light waves, such as those generated during radio-wave and infra-red data communications.

The end user viewing device is similar in general architecture to the reel converter and viewer server.

### Edge Detection and Image Orientation

The present invention provides a method of converting image files output from a scanner to a viewable representation of the original roll of film. As scanners typically only take an image of a portion of the roll of film and output that as an image file, viewing these digital images in a manner which presents the images such that they faithfully represent the actual positioning and orientation of the images in relation to the roll film they were taken from.

The digital images output from the scanner may or may not include an object in the digital image. As used in the present application, an image object is any recognizable content recorded on the roll film. As an example, in the case of county records stored on microfilm, the image object is the page of the county records file (or book). Any type of document recorded on roll film may be an image object. Other examples of image objects include photographs, pictures or artwork, and the like.

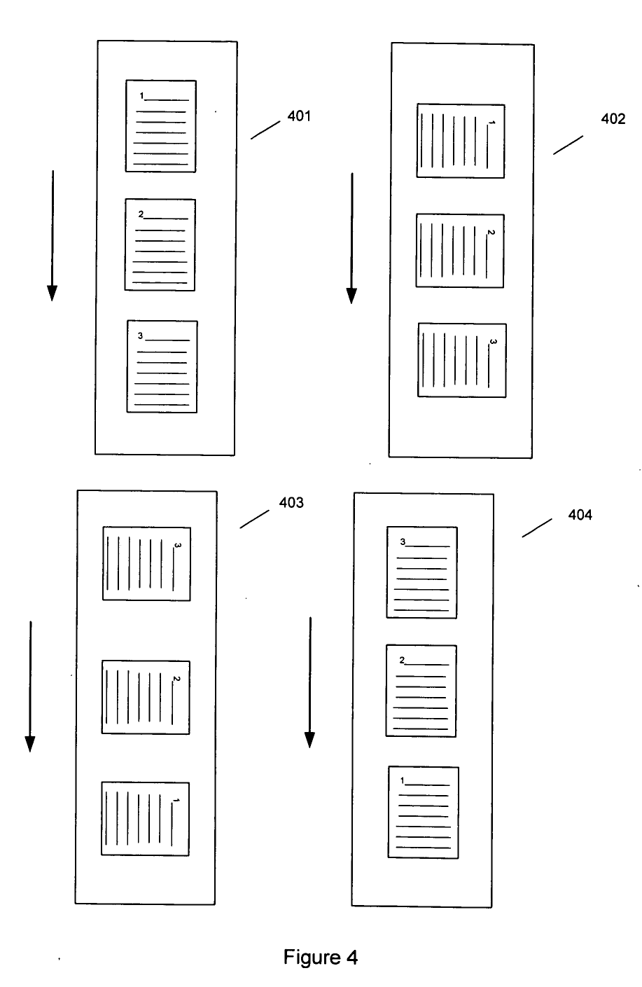

FIG. 4 is a generalized block diagram of images from a reel scanner illustrating the orientation of the images according to one embodiment of the invention. Each image 401 is a segment, or slice, of the roll of film fed into the scanner. In the presently preferred embodiment, the roll film is scanned in its entirety, creating a complete digital record of the roll film.

The individual images of a roll film are typically filmed in one of four possible orientations. The images may be oriented top to bottom as shown in 401, bottom to top (typically referred to as “CineMode”) as shown in 404, left to right as shown in 402, or right to left (typically referred to as “Comic Mode”) as shown in 403. (The directional arrow next to each roll film segment indicates the direction of the roll film pointing from the top, or beginning, of the roll to the bottom, or end, of the roll.) In creating a digital image of the roll film the original orientation of the filming of the roll and the orientation the operator of the reel scanner feeds the roll into the reel scanner determine the orientation of the digital output. In the presently preferred embodiment, the operator of the process of converting the digital image files to a digital reel image enters the orientation of the individual images into the system, as described below.

The individual images of a roll film are “merged” by the present invention to form a “continuous” digital roll. To merge the individual images to form a “continuous” digital roll the present invention creates a metadata file which contains information a viewer running on a computer uses to allow a person to scan through the “continuous” digital roll in much the same way they could view a roll film with a conventional viewer (such as a microfilm viewer). Thus, in this manner the present invention allows a viewer running on a computer to accurately emulate the directional and informational aspects of viewing images by a conventional roll film viewer, using the individual digital images and the associated meta-data file.

### Creating a Digital Image Orientation File

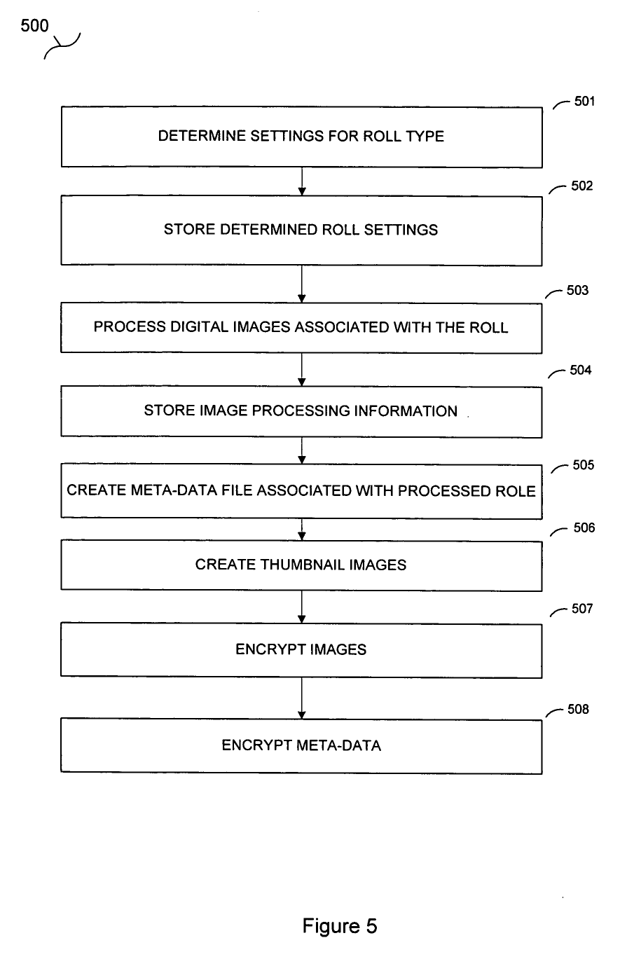

FIG. 5 is a generalized flow diagram illustrating the process 500 of creating a meta-data image interpretation file for viewing the digital image files of the roll image. At step 501 the system determines the settings for the type of roll film. The settings may be entered by an operator of the image processing system, may be received from the image processor, or may be determined by a process of the present invention. Depending upon the implementation of the present invention, the example settings may include relative image orientation (both image order information and image position information), parameters specifying image object orientation, position, location or direction, image content or identifying information, roll film content or identifying information, number of images associated with a roll, minimum image size, image resizing information (either reduction or enlargement), noise correction settings information, encryption or security information, and image pixel information (number of pixels, size of pixels, pixel correction or alteration information, white page on a black background, white page with a border on a black background, a page in a fixed position on each fame, etc.).

At step 502 the system stores the roll settings. Preferably, the roll type settings information is stored in an XML file for later use, but may be stored in any format and in either storage or memory for use with the processing of the digital images of the roll film. The present invention also allows roll type settings to be stored and associated with multiple groups of images, corresponding to processing multiple rolls of film, as for example with batch processing of roll film. The present invention may store all of the roll settings from step 501, or a subset of the roll settings from step 501.

At step 503 the system processes the digital images of the roll film according to the settings for the roll type determined in step 501. The processing of the digital images may include resizing of the images (the resizing may be temporary to aid in processing), merger of multiple images into a singe image file (for example, grouping three digital images into a singe digital image file), separation (or partition) of image files into multiple image files (for example, to “Crop” detected objects into separate image files), compression of image file, noise or error correction of image files, truncation or reshaping of image files, location of object(s) in image files (for example, location of pages on digital images of roll microfilm), reorient images (for example, rotate, reverse, or re-order images), sort objects (sort objects according to order or direction information), merge intersecting objects, remove border or edge objects (for example, a barely legible portion of a page intruding into the digital image of another page may be removed or altered), and creation of a list of images, objects, and processing actions taken. The output of step 503 may alter the digital image files, create new digital image files for use in an image viewer, or both. Additionally, the output of step 503 may render the post processing digital image files unchanged, while outputting the information obtained from processing copies (or other representations) of the digital image files.

Note, alternate embodiments of the present invention could allow for improvement of the digital images (that is, defect correction or removal), to aid in viewing, or could specifically prevent improvement, as for example where preservation of exact images of roll film is desired. In embodiments which do not alter the digital images output for viewing, the digital images may be altered as part of the process of creating the image interpretation file (for example, to aid in the location of objects).

After processing the digital images in step 503, the system stores the information received from the processing at step 504.

At step 505 the system creates the meta-data image interpretation files associated with the processed digital images. In the presently preferred embodiment meta-data image interpretation files is an XML file, with tags specifying the use or type of data stored in the meta-data image interpretation file. However, alternate embodiments could use other formats for storing or organizing the information in the meta-data image interpretation file.

The meta-data image interpretation files include information associating on the associated digital images and other meta data which allows the image viewer to present the digital images as a roll film, as well as present other meta-data which a person using the image viewer may find helpful in locating and viewing objects (such as pages from a microfilm or microfiche). Examples of meta-data information that may be included in the meta-data interpretation file include: roll identification information, roll content information, image file identification information, image file content information, image object identification information, image object content information, resizing information, merger information, separation information, compression information, noise or error correction information, truncation or reshaping of image files information, location of object(s) in image files information, roll index information (such as the location of books, or the starting page of an object, within a roll), reoriented images information, sorted objects information, merge intersecting objects, removed border information, and information specifying the number of images, objects, and processing actions taken. Additionally, the meta-data interpretation file may include further security or encryption information, as well as file name or location information specifying the location of the digital images on a storage medium or computer system or network.

In the presently preferred embodiment the system creates thumbnail images at step 506. The thumbnail size images are scaled down version of the digital images associated with the meta-data interpretation file. These thumbnail images may be used for navigation or other purposes by persons using the image viewer to view the digital images of the roll film. While the presently preferred embodiment generates thumbnail images for inclusion with the meta-data interpretation file and digital images, alternate embodiments could do without thumbnail images.

At step 507 the system encrypts the digital images (and optional the thumbnail images) for security purposes. At step 508 the meta-data interpretation file is encrypted for security purposes. Meta-data relating to the encryption of ether the digital images or the meta-data interpretation file may be included in the meta-data interpretation file at the time of its creation, at step 505, or during the encryption.

### Output Files from Image Processing

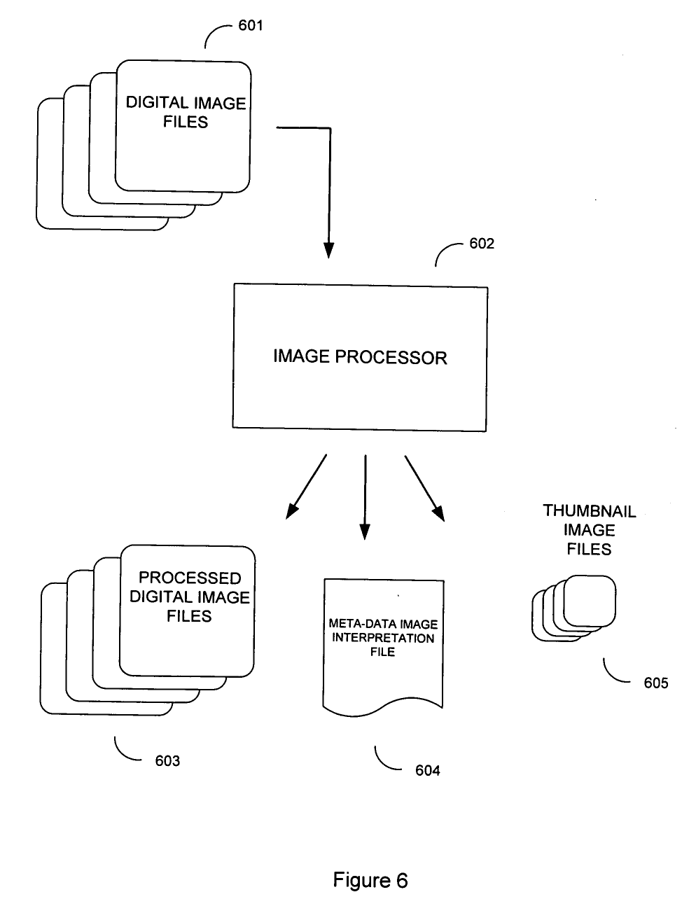

FIG. 6 is a generalized block diagram illustrating the output from the process of creating a meta-data image interpretation file for viewing the digital image files of the roll image, described above in connection with FIG. 5. The reel converter and viewer server 602 runs the process 500 for creating a meta-data image interpretation file. The input for the process of creating a meta-data image interpretation file are the digital image files 601 which are output from the reel scanner (based upon the roll type configuration settings). In the presently preferred embodiment, the process 500 has three outputs, the processed digital images 603, the meta-data image interpretation file 604, and the thumbnail images 605.

While the presently preferred embedment outputs three types of files from the meta-data interpretation file creation process, alternate embodiments of the present invention could combine these different file types into one or two file types, or may output more than three file types, to suit the needs of the implementation.

### Preparing Digital Image Output File

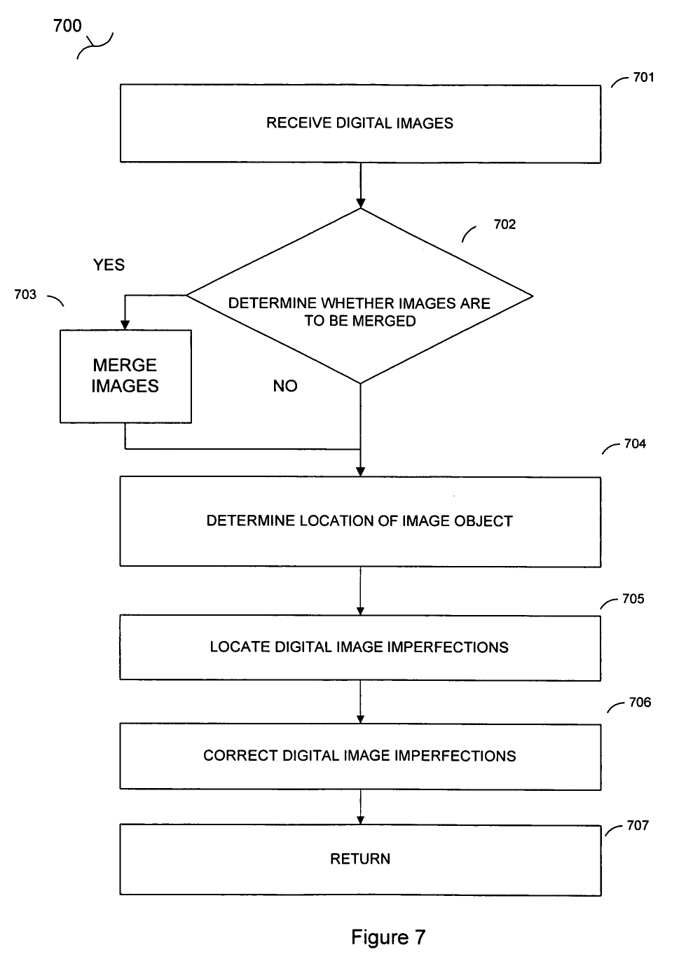

FIG. 7 is a generalized flow diagram illustrating the process of preparing the digital image files output from the reel scanner for viewing by a viewer. As discussed above in connection with FIGS. 5 and 6, the present invention creates a meta-data file which is associated with the images corresponding to a scanned roll image. This meta-data file includes information for the viewer to present and navigate among the digital images. Additionally, the present invention may prepare the digital images to correct defects or errors in the digital images, thereby improving the viewing experience, or may process the digital image files to improve the ability to extract information for preparing the digital image interpretation files. Process 700 illustrates some of the preferred defect correction and enhancement features of the present invention.

While one embodiment of the present invention could allow for improvement of the digital images (that is, defect correction or removal), to aid in viewing, or could specifically prevent improvement, as for example where preservation of exact images of roll film is desired. In embodiments which do not alter the digital images output for viewing, the digital images may be altered as part of the process of creating the image interpretation file (for example, to aid in the location of objects). Accordingly, process 700 may be adapted to provide information for the image interpretation file, without changing the digital files output and used by the digital reel viewer (in such an embodiment, copied, memory resident, or otherwise functionally equivalent files, may be processed including such steps as resizing, cropping, pixel removal, or the like, to aid in the location of an image object to provide information for the image interpretation file).

As described above, an image object may or may not be included in a given image file. When an operator uses a reel scanner to process a roll film the reel scanner may take images of section of the film which do not include an image object. Also, the reel scanner may also take digital images which have more than one image object. An example of this occurrence is when a digital image captures a portion of the next image object, as sometimes occurs when taking digital images of microfiche documents, such as county records or the like. The portion, or sliver, of the next image object may be unreadable in a given digital image, or may be readable when merged with a portion of the next digital image in the sequence.

At step 701 the system receives the digital images from step 503 of process 500. At step 702 the system checks to determine if the images are to be merged or partitioned. In the presently preferred embodiment, if several images are to be merged this will be specified in the settings. If at step 702 the system determined that images were to be merged (or partitioned) the system proceeds to step 703 where the merger (or partitioning) occurs. At step 703 the orientation and sequencing information from the settings is used in the merger (or partition) of the digital images. In the event the system determines there is no merger (or partitioning) of images, or after step 703, the system proceeds to step 704.

At step 704 the system locates the image object in the digital image. Typically, the image object is distinct from the background of the digital image. As a clarifying example: in the event of a records book recorded on microfiche, the page of the records book is much lighter color, near white, while the background is quite dark, typically near black. While the text on the page may appear black, and there may be imperfections in the background (from the imaging, from dirt or imperfections, or from scratches in the roll film). Despite this, the image object may be relatively easy to identify as a large (relative to text or imperfections) having a different color from the background. In the event the quality of the roll film is poor, or the scanner creates a low quality digital image, location of the image object may not be easy. In such a case, correcting for scratches, noise removal, inverting (positive to negative, or vice versa), fattening white pixels, looking only at certain regions of interest (e.g. the top 200 pixels, bottom 200 pixels), etc., may be performed. For example, in some poor quality roll film, only the top edge is distinctive of the page of a recoded book (i.e. the image object). In such an example, the present invention could look only at the top portion of the film, detecting the top edge of the page and then fixing the image object height from the top edge to correspond with the page recorded in the microfilm.

At step 704 the system identifies the specific location and size of the image object (for example, by specifying its pixels and dimensions of pixels from the edge of the digital image).

At step 705 the system locates digital image imperfections. Once the image object has been determined, the system may locate other objects, typically scratches and other defects which have been picked up and recorded by the reel scanner. As the size and shape of the image object are typically know (and may be specified in the settings to facilitate image and imperfection identification and location, for example by specifying a minimum image object size or dimension), it is relatively simple to detect imperfections, which show up as contrasting pixels in areas which are expected to be of another color (for example, small areas of light pixels typically represent a flaw in the digital image).

If image improvement and/or correction is desired, at step 706 the system corrects the defects identified and located in step 704. Defect correction/minimization may be as simple as inverting the color of the pixels identified with a digital image defect (e.g. from light to dark). Other options include cleaning and reducing noise (for example removing a white pixel when all the surrounding pixels are black), trim or remove pixels, fatten or add pixels, and merge image objects (which id different from merging two digital images, as the digital images are different files, while the image objects are areas of pixels within a digital image and are merged to create a single image object).

After completing step 706 the system returns to step 503 of process 500 at step 707.

The present invention provides a process of creating digital image files which include the meta-data to allow the digital images to be viewed in sequence, with the correct orientation, thereby providing the end user with the ability to view the digital images in much the same manner as they would view the original roll film, without the disadvantages associated with roll film. The present invention provides meta-data information which aid in the navigation of the digitized roll film and in the location of object images.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method of creating a digital image interpretation file, comprising:
receiving a plurality of digital images from an image scanner, the plurality of digital images corresponding to segments of roll film;
processing the plurality of digital images to determine their relative position;
storing relative position information in the image interpretation file; and
associating the image interpretation file with the plurality of processed digital images.

2. The method of claim 1, wherein the associating the image interpretation file includes identifying a unique file name corresponding to the plurality of processed digital images.

3. The method of claim 1, wherein processing the plurality of digital images further includes determining the relative position of an image object in the digital image file, and wherein relative position information of the image object is stored in the image interpretation file.

4. The method of claim 1, further comprising:
locating an image object in the digital image, and
including image object position information in the image interpretation file.

5. The method of claim 1, wherein the relative position information includes information entered by an operator of the image scanner.

6. The method of claim 1, wherein determining position information of an image object located in at least one digital image is performed by selecting at least one image manipulation process from a list of image manipulation processes, the list including:
resizing the digital image,
reducing noise in the digital image,
trimming the digital image,
removing pixels from the digital image,
adding pixels to the digital image,
merger portions of the digital image with anther digital image or portion thereof,
cropping the digital image,
compressing the digital image,
reshaping the digital image, and
reorienting the digital image.

7. A method of preparing a plurality of digital images for viewing, comprising:
receiving a group of digital image files, the digital image files corresponding to a roll film;
determining settings associated with the received digital image files;
creating an associated image interpretation file, said associated image interpretation file for use by a viewer to allow the group of digital images to be viewed in a scroll mode of the viewer; and
storing at least one determined setting in the associated image interpretation file.

8. The method of claim 7, further comprising:
processing the digital images to obtain image object information; and
storing image object information obtained from processing the digital images in said associated image interpretation file.

9. The method of claim 8, further comprising:
creating a plurality of thumbnail images corresponding to the received digital images, and
storing thumbnail image information in said associated image interpretation file.

10. The method of claim 7, wherein processing the associated image interpretation file includes storing information specifying cropping an image file from said group of digital image files.

11. The method of claim 7, wherein processing the associated image interpretation file includes storing information specifying partition an image file from said group of digital image files.

12. The method of claim 7, wherein processing the associated image interpretation file includes storing information specifying the position of an image object in at least one of the digital image files.

13. The method of claim 7, wherein the processing of the image file includes resizing the image file.

14. The method of claim 7, wherein the processing of the image file includes removing imperfections in the digital image.

15. An image interpretation file, comprising:
data specifying the image files associated for viewing as a roll film;
data specifying the sequence of images files; and
data identifying the roll film associated with the image files associated for viewing as a roll film.

16. The image interpretation file of claim 16, further comprising:
data specifying content information of at least one image object in at least one image file.

17. The image interpretation file of claim 16, further comprising:
data specifying the position of at least one image object in at least one image file.

18. The image interpretation file of claim 16, further comprising:
data specifying the image file contained an image object.

19. The image interpretation file of claim 16, further comprising:
data specifying identifying information for at least one thumbnail image associated with the image files associated for viewing as a roll film.

20. The image interpretation file of claim 19, further comprising:
data specifying the association between the at least one thumbnail image and a corresponding image file.
